(19) United States
(12) Patent Application Publication
(10) Pub. No.: US 2022/0398679 A1
(43) Pub. Date: Dec. 15, 2022

(54) ELECTRONIC NOTARIZATION AND SIGNING OF A DOCUMENT

(71) Applicant: Stavvy, Inc., Boston, MA (US)

(72) Inventors: William Ung, Somerville, MA (US); Matthew Sluggett, Waltham, MA (US); Joshua Feinblum, Weston, MA (US); Konstantinos Ligris, Boston, MA (US)

(21) Appl. No.: 17/840,054

(22) Filed: Jun. 14, 2022

Related U.S. Application Data
(60) Provisional application No. 63/210,551, filed on Jun. 15, 2021.

(51) Int. Cl. G06Q 50/18; H04L 9/32

(52) U.S. Cl. CPC G06Q 50/18; H04L 9/3242; G06Q 2220/18

(57) ABSTRACT

A method is provided for electronically notarizing and signing a document. The method can include receiving data characterizing a first document including a first electronic signature and generating a first secure document by at least hashing the first document with a private key. The first secure document can include a first unique identifier. The method can include generating a second document corresponding to the first document and excluding the first unique identifier. The second document can be provided for a second electronic signature to be applied by a second user. A second secure document including a second unique identifier can be generated and combined with the first secure document into a document folio including a third unique identifier identifying a cryptographic tamper seal associated with the document folio. Related systems and techniques are also provided.

### CROSS-REFERENCE TO RELATED APPLICATIONS

This application claims the benefit of and claims priority under 35 U.S.C. § 119(e) to U.S. Provisional Application 63/210,551 filed on Jun. 15, 2021. The entire contents of which is expressly incorporated herein by reference in its entirety.

### TECHNICAL FIELD

The subject matter described herein relates to electronic signing and notarization of documents, for example, electronic notarization of documents.

### BACKGROUND

Notarization of documents can be required in a variety of financial and other business or personal transactions, such as real estate transactions including deeds, mortgages and other instruments. In some transactions, multiple notarizations may be required for a single document. Often, electronic versions of documents can be exchanged between multiple people or entities who can be required to sign a particular document, e.g., signors. The signors can include, for example, a mortgagee, a mortgagor, a seller, witnesses, and/or a public notary who can provide a notarization of the document. Notarizations can be performed in person, where a signor can attest to the validity of their signature in person to the notary. Notarizations can also be performed remotely or via electronic (e.g., “online” or “digital”) methods. Digital notarization can include when the signatory presents themselves in person to a notary public, but the signing and notarization occurs on a computing device such as a tablet, or smart phone without the use of pens or stamps and where the signature is generated by the computing device based on inputs to the computing device provided by the signatory.

Remote, digital, or online notarizations of documents can be cryptographically sealed which can help with preventing tampering and fraud. Cryptographic sealing can show when a document has been modified from the original. Cryptographic sealing can also include cryptographic tamper sealing, tamper sealing, tamper proofing, and can include application of digital signatures or cryptographic signatures to documents. It can be important to maintain the authenticity and security of electronic documents, as well as the signatures and/or notarizations included therein, when conducting transactions requiring multiple signature and notarization events to properly execute a transaction in which an authentic version of a signed, notarized document associated with the transaction is required.

### SUMMARY

In an aspect, a method for electronically notarizing and signing a document is provided. In an embodiment, the method can include receiving data characterizing a first document including a first electronic signature applied by a first user. The method can also include generating a first secure document by at least hashing the first document with a first private key. The first secure document can include a first unique identifier. The method can further include generating a second document corresponding to the first secure document. The second document can exclude the first unique identifier. The method can also include providing the second document for a second electronic signature to be applied by a second user.

One or more of the following features can be included in any feasible combination. For example, in one embodiment, prior to generating the first secure document, a first annotation indicating a third electronic signature required to be applied by the first user can be added to the first document.

In another embodiment, the method can further include receiving the second document including the second electronic signature applied by the second user. The method can also include generating a second secure document by at least hashing the second document with a second private key. The second secure document includes a second unique identifier. The method can further include providing the first secure document and the second secure document.

In another embodiment, the second secure document can include a first visual representation of the first electronic signature and a second visual representation of the second electronic signature. In another embodiment, prior to generating the second secure document, a second annotation indicating a fourth electronic signature required to be applied by the second user can be added to the second document. In another embodiment, the first electronic signature can be applied by the first user using a first client computing device; the second electronic signature can be applied by the second user using a second client computing device; and generating the second document can be performed by a server remote from the first computing device and the second computing device. In another embodiment, the second user can be remote from the first user.

In another embodiment, the method can also include providing the first document for electronic signature by the first user. In another embodiment, generating the first secure document can further include embedding the first unique identifier within a file structure of the first secure document.

In another embodiment, the method can also include generating a first audit list based on the first secure document and/or generating a second audit list based on the second secure document. In another embodiment, the first audit list can include at least one of a date of the first electronic signature, a name associated with the first electronic signature, a license number associated with the first electronic signature, or a notary seal associated with the first electronic signature. The second audit list can include at least one of a date of the second electronic signature, a name associated with the second electronic signature, a license number associated with the second electronic signature, or a notary seal associated with the second electronic signature.

In another embodiment, the method can also include combining the first secure document and the second secure document into a document folio including a third unique identifier identifying a cryptographic tamper seal associated with the document folio. In another embodiment, the document folio can include computer-readable and executable content, which when executed can provide at least one of a first chronological list identifying historical data associated with application of the first electronic signature to the first document or a second chronological list identifying historical data associated with application of the second electronic signature to the second document.

In another embodiment, the first document can be associated with execution of a loan document, an affidavit, a power of attorney, a deed, a property title, a deed of trust, an escrow, a will, an insurance policy, or a contract.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### DESCRIPTION OF DRAWINGS

FIG. 1 illustrates an example workflow for generating documents including multiple notarizations performed at different times according some embodiments of the subject matter described herein;

FIG. 2 illustrates an example architecture of a system for generating documents including multiple notarizations performed at different times according to some embodiments of the workflow of FIG. 1 as described herein;

FIG. 3 illustrates an example signature including a unique signature identifier generated by the system of FIG. 2 according some embodiments of the subject matter described herein;

FIG. 4 illustrates an example document including a unique document identifier generated by the system of FIG. 2 according some embodiments of the subject matter described herein;

FIG. 5 illustrates an example notary profile interface provided by the system of FIG. 2 according some embodiments of the subject matter described herein;

FIG. 6 illustrates an example document annotation interface provided by the system of FIG. 2 according some embodiments of the subject matter described herein;

FIG. 7 illustrates an example document portfolio interface provided by the system of FIG. 2 according some embodiments of the subject matter described herein;

FIG. 8 illustrates an example cryptographic seal provided in a document generated by the system of FIG. 2 according some embodiments of the subject matter described herein;

FIG. 9 illustrates an example acknowledgment identity (ID) image according to some example implementations of the current subject matter;

FIG. 10 illustrates an example process flow diagram of a method for generating documents including multiple notarizations performed at different times performed by the system of FIG. 2; and

FIG. 11 illustrates an example data flow diagram of data provided by the system of FIG. 2.

Like reference symbols in the various drawings indicate like elements.

### DETAILED DESCRIPTION

Notarizations provided remotely via electronic or online methods or in person digitally can apply a notary seal and a tamper seal to a document being signed during a workflow associated with a transaction. For example, a home loan agreement signed by a purchaser of the home and by a representative of the financial institution issuing the home loan to the purchaser. Although the foregoing embodiments may be described in relation to notarization of documents in a mortgage financing workflow, the system and methods described herein can be used in any variety of non-limiting electronic document signing workflows that can be associated with multiple digital signature, or multiple document execution steps (e.g., multiple document signing steps) other than notarization, including affidavits, powers of attorney, deeds, property titles, deeds of trust, escrows, wills, insurance policies, contracts, as well as modifications to documents associated with the aforementioned document types or transactions, or the like.

A notary public (e.g., notary, public notary, justice of the peace, judge, clerk, government agent, consular officer, military officer, or lawyer in certain jurisdictions) is a public officer constituted by law to serve the public in non-contentious matters usually concerned with estates, deeds, powers-of-attorney, and foreign and international business. A notary's main functions are to administer oaths and affirmations, take affidavits and statutory declarations, witness and authenticate the execution of certain classes of documents, take acknowledgments of deeds and other conveyances, protest notes and bills of exchange, provide notice of foreign drafts, provide exemplifications and notarial copies, and perform certain other official acts depending on the jurisdiction. Any such act is known as a notarization. The term “notary public” refers to common-law notaries and should not be confused with civil-law notaries.

A cryptographic seal can be applied to indicate that the document has not changed since it was executed. As a result, the document can be made tamper proof. In electronic, digital, or online document signing workflows, a cryptographic signature can be used as the cryptographic seal to prove that the document has not been tampered with. When a document is required to be transmitted to multiple computing devices and for signature by multiple parties, the risk of tampering and fraudulent actions on the document can increase. Document tampering can negatively impact the security and authenticity of the document, the signatures, and/or notarizations included in the document. As a result, the document may be unacceptable for use in certain transaction workflows.

A person can sign a document electronically by adding a digitally created signature to the document, which is also in digital form. However, such an approach is vulnerable to tampering as anyone can create the digital signature and the electronic document can be easily modified. Accordingly, some approaches to digital signing of a document include cryptographic sealing that includes applying a cryptographic identity or signature to the digital document as part of applying the digitally created signature. For example, a signer's private key can be used to create a first identifier (e.g., a unique identifier) for the document by hashing the private key and the document to create the identifier. Someone looking to verify whether the document has been tampered with or modified can hash the document with the singer's public key to produce a second identifier. If the first identifier and the second identifier are the same, the document can be verified as unmodified. However, if the first identifier and the second identifier are different, the document has been modified and therefore it can be determined as having been tampered with. But it is not possible to remotely notarize a document that has been made tamper proof (e.g., by using a private key, as described above), because once the first identifier is created by the signer, the document cannot be modified to include a second signature (e.g., notary signature, seal, and the like) while preserving the ability to verify that the document has not been modified with respect to the first signer.

Accordingly, some implementations of the current subject matter include an approach to applying a digital signature (e.g., a cryptographic signature or the like) that enables the entire document, including both the first signature and the second signature, to be tamper proof. In some implementations, after the document has been signed and the first identifier is applied to the document, an image of the document is created as a second document and provided for the second signature (e.g., for notarization). The second document, which includes the image of the first document including first signature, can be signed and a second private key used to create a second unique identifier that can be applied (e.g., associated with) the second document. The second document thus contains both signatures and the first document is unmodified, thereby allowing for detecting if tampering has occurred. The first and second document, along with the first and second identifiers, can then be provided as the signed and notarized document, which is tamper evident for all signatures. By first applying the first signer's private key, then imaging the document (rather than further modifying the first document) to create a second document for signature by a second signer remote from the first signer, some implementations of the current subject matter can allow for secure and verifiable remote digital signing and notarization of electronic documents.

Some implementations of the current subject matter can mitigate document tampering when multiple signatures and notarizations are provided by remote parties at different times. For example, a first party may be considered remote from a second party when the first party is not physically co-located with the second party and thus unable to provide a signature or notarization to a document in the same physical environment or at substantially the same time as the second party. A first party can be remote from a second party spatially and/or temporally. Thus, a first party can be remotely located from a second party in regard to a location at which a document is signed and/or notarized. A first party can also be remotely located from a second party in regard to a time at which the first party signed and/or notarized a document relative to a time at which the second party signed and/or notarized the document.

Some implementations of the current subject matter can provide for multiple notarizations or signings of a document without modifying the original document and can do so in a secure environment. Some implementations of the current subject matter herein can allow a portfolio of documents requiring multiple signatures and notarizations at different times to be securely transmitted and stored.

An example document portfolio, such as one used in a mortgage loan servicing workflow can include multiple documents, each of which can require one or more signatures and/or notarizations. For example, a mortgage loan document portfolio can include a sample closing document previously signed by a notary public and a borrower in a first meeting. The portfolio can also include an audit trail (e.g., audit list) for the sample closing document identifying the events required by law to be completed to indicate the actions performed at the first meeting. The portfolio can also include an acknowledgement document identifying a second version or copy of the sample closing document as signed by the notary public and a bank representative in a second meeting. The portfolio can also include an audit trail for the acknowledgement document identifying the events that are required by law to be completed to indicate the actions performed in the second meeting.

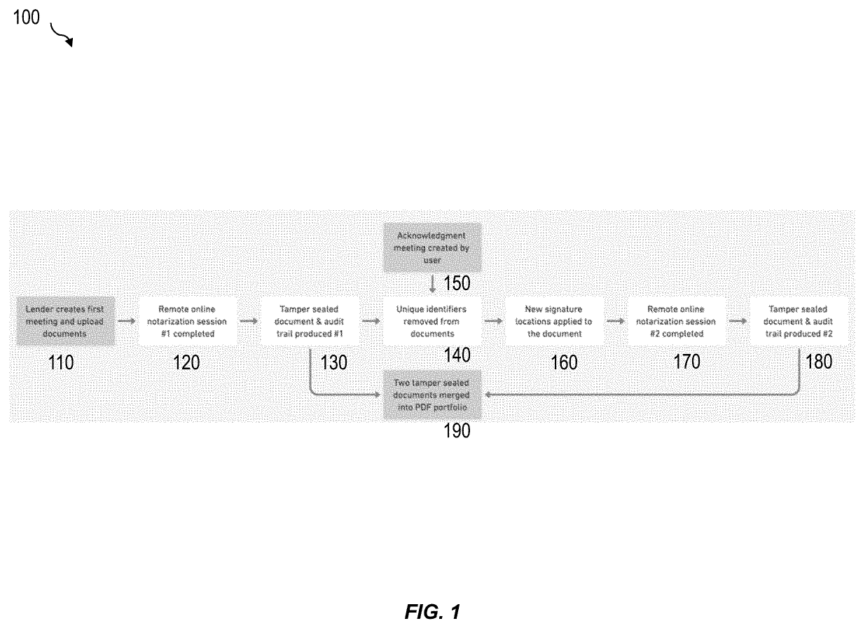

FIG. 1 illustrates an example workflow 100 for generating documents including multiple notarizations performed at different times according some embodiments of the subject matter described herein. The workflow 100 of FIG. 1 can be implemented using the system and methods described herein to generate a portfolio of documents. In some embodiments, the documents can be in a portable document format (PDF), although documents in other formats can be generated, stored, and utilized in the system without limit. To prepare to conduct the workflow 100, a notary or system administrator can complete a profile on the system described herein and can provide proof of the notary's credentials. For example, the notary can provide proof of their appointment as a notary, an identification number or means, the state in which they are commissioned as a notary, and an acknowledgement based assessment or authentication of their notary credentials. In some embodiments, the notary can provide a digital certificate, such as an x509 certificate, as another form of authentication. In some embodiments, the system described herein can utilize the notary's x509 certificate as part of the cryptographic seal that will be included in their digital notary seal. In this way, the notary has the rights necessary to generate a seal for use in remote online notarizations.

As shown in FIG. 1, at 110, the notary or system administrator can create the first meeting and upload documents requiring signatures from the meeting participants. For example, a notary approved and registered in the system can create a loan modification meeting, upload the necessary loan modification documents requiring signature and notarization, and can invite the required participants to the meeting to sign the loan modification documents. The notary or system administrator can annotate a loan modification document by adding the required field(s) necessary to complete the document. The annotations can include, but are not limited to, an indication of a required signature, an indication of required initials, an indication of a required date, an indication of a required name, an indication of a required title, an indication of required text field, and an indication of a required notary seal. After annotating the document, the notary will mark the document ready for signature by the meeting participants. Portions of the document may not include annotations.

As shown in FIG. 1, at 120 of workflow 100, the remote online notarization session #1 is takes place. During that meeting, for example, participants can join the meeting at the scheduled time and can verify their audio and visual requirements to interact with the system. Upon joining the meeting, the notary can issue the signers a knowledge based authentication challenge to perform identity verification of the signers so as to secure the meeting. The participants can sign their respective annotated fields. If there is a missing annotation, the notary or system administrator can add a new annotation without having to leave the document or meeting. Any changes made to the document can be made live and can be viewed by all participants. The notary can then affix their seal and can mark the document as completed. The document can then be locked from re-signing in the same meeting. The notary can have the right to sign any other document added to the meeting or session.

As shown in FIG. 1, at 130 of workflow 100, a tamper sealed document and audit trail is produced. For example, when the notary marks the document as completed, it can be tamper sealed and an audit trail document, such as an audit list, can be created. The tamper sealed document can be now be a certified document containing executed signatures of the meeting participants. Each signature and each document can have a unique identifier. The unique identifier can be applied to the document (or to each document) so that in the event of a challenge, the system can identify the meeting the document was associated with. A challenge can be a formal or informal challenge and can seek to verify the authenticity or validity of a change to a document, a participant in a meeting, a signature on a document, or the like. The audit trail document or audit list can include a list of events that happen during the meeting and the document itself. In some embodiments, the audit trail document or audit list can be captured as a plain text document, which can be contained in a pdf. The audit trail document or audit list can include all “events” related to the document, such as any changes (and by whom), signers/signings, notations, ID verification, presence of or departure from an individual in a meeting, meeting times, meeting dates or the like. The last event in an audit trail document or audit list can be the time of day at which the document is tamper sealed. The audit trail document or audit list can also contain a unique identification number.

As shown in FIG. 1, at 140 of workflow 100, the unique identifiers associated with the tamper sealed document can be removed. For example, unique identifiers associated with any signatures (e.g., a participants signature or a notary signature) can be removed from the tamper sealed document. In some embodiments, the notary seal signature block and the corresponding unique identifier associated with the notary seal signature block can be removed. In this way, the notary seal signature block cannot be changed or manipulated in subsequent meetings or signing sessions.

As shown in FIG. 1, at 150 of workflow 100, an acknowledgement meeting can be created and can be linked to the original meeting. In some embodiments, the acknowledgement meeting can include a second meeting for the document signed in the first meeting to be further signed by additional participants in the second meeting. For example, a second notary, different from the initial notary, and a second group of participants, different from the initial participants, can review and sign the first document to approve any changes made therein. For example, an acknowledgement meeting can include a second notary and a representative of a bank (e.g., the loan/mortgage owner) responsible for reviewing and approving the signed loan modification document and any updated terms changed therein.

As shown in FIG. 1, at 160 of workflow 100, new signature locations can be applied to the document that was initially signed in the first meeting. For example, the document can be unlocked so that new annotations can be applied noting new signatures that can be required at the acknowledgment meeting (i.e., the second meeting). An authorized representative from the bank can see the previous information included in the initial document version including the seal, signature, document and signature identifiers. The notary seal can be generic and does not need to apply to a specific notary until they are added when the notary or system administrator starts the second meeting.

As shown in FIG. 1, at 170 of workflow 100, a second meeting for remote online notarization of the document is completed. The signers can join the second meeting and the notary can annotate and sign the document in the same manner described in relation to 120 of FIG. 1.

As shown in FIG. 1, at 180 of workflow 100, the document is tamper sealed and an audit trail document is produced. The document can be tamper sealed and an audit trail document or an audit list can be generated as described in relation to 130 of FIG. 1. For example, unique identifiers associated with the additional signatures and/or notary seal, as well as the signed document and the audit trail document or audit list, can be generated and included in the tamper sealed document.

As shown in FIG. 1, at 190 of workflow 100, two tamper sealed documents can be merged into a document portfolio. For example, the two tamper sealed documents can be merged into a PDF document portfolio file that can include embedded links (e.g., computer-readable and executable content, such as a universal resource locator (URL)). When a user clicks or otherwise executes the embedded links, a user can be provided with the audit trail of the document portfolio file. The document portfolio can also include an audit trail document or an audit list that can be associated with each document contained in the document portfolio. Each audit trail document or audit list can include executable content associated with an audit trail of events associated with a respective document included in the document portfolio file. The audit trail document or audit list can include a list of events that occurred with respect to a meeting or signing session, and thus can represent an audit trail associated with the meeting or signing session. For example, the audit trail document corresponding to the first document from the first meeting or signing session (as well as any document associated with any meeting or signing session, whether they are first meetings or initial signing sessions or second meetings or acknowledgement meetings/signing sessions) can include a list of signing events that occurred at each meeting with respect to a particular document, participants of the meeting who signed a document, and an IP address of a computing device used by the participants to sign a document, or the like. The audit trail document or audit list can also include a time stamp at which each signature was applied to a document. A unique identifier can also be applied to the audit trail document or audit list of the document portfolio file so that it can be traced.

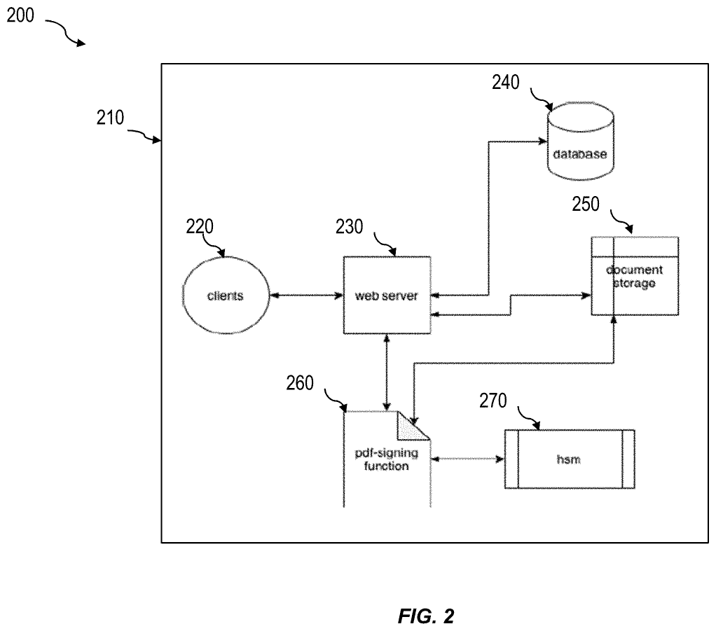

FIG. 2 illustrates an example architecture 200 of a system 210 for generating documents including multiple signatures and/or notarizations performed at different times according to some embodiments of the workflow 100 of FIG. 1 as described herein. The architecture 200 can be implemented as a client-server architecture at a single installation site or as a cloud-computing architecture implemented in multiple remotely located sites.

An example data flow associated with the workflow 100 of FIG. 1 can be described in relation to the system 210 as shown in FIG. 2. For example, a notary can utilize a client computing device 220 to query a web server 230 for documents available for initial signature during a first meeting or for subsequent signature during a second meeting, e.g., an acknowledgement meeting. The web server 230 can query the database 240 to get a list of documents which are available. The notary and any meeting participants can electronically notarize or sign documents via the client computing device 220.

The notary can send a request to create a meeting (e.g., an initial meeting for initial signatures or a subsequent acknowledgment meeting for additional signatures) from the client computing device 220 to the web server 230. The request can include the available document that corresponds to the meeting. The web server 230 can create a first reference in the database 240 identifying an original document and a second reference identifying an acknowledged or second version of the original document

The notary can annotate the documents using the client computing device 220. The annotations can be sent to the web server 230 to be processed and can be stored in the database 240.

A second meeting or an acknowledgement meeting can be conducted and the data can be sent from the client computing device 220 to the web server 230 for additional signatures. The data can also be provided to a 3^{rd} party service that provides audio/video communication between all parties.

The document can be marked as finalized and the notary can send a request via the client computing device 230 to the web server 230 to finalize the second meeting, e.g., the acknowledgement meeting. The request can further include finalizing the acknowledgement documents signed during the second meeting.

The web server 230 can serialize the annotations and can query the database 240 for audit log events. The web server 230 can send the request and documents to the PDF signing function 260.

The PDF signing function 260 can download the signed initial document or the signed acknowledgement document from document storage 250. In some embodiments, the PDF signing function 260 can receive hashed versions of documents. The PDF signing function 260 can remove any previous digital, cryptographic signatures from the documents and can process the new annotations and the audit log to generate new tamper sealed documents.

A cryptographic signature can be computed in the hardware security module (HSM) function 270 and can be applied as a unique identifier to the documents. The PDF signing function 260 can call the HSM function 270 to sign the document unique identifier value applied to each document. The HSM function 270 can include a private key for which a certificate authority has issued a certificate. In some embodiments, the PDF signing function 260 and the HSM function 270 can be configured as modules or applications containing computer-readable, executable code. The modules or applications can be configured on the web server 230 or on another computing device communicably coupled to the web server 230. In some embodiments, the HSM function 270 can be a hardware security module configured to store and manage digital keys and to perform data encryption and decryption operations.

The unique identifier (e.g., the cryptographic signature) can be embedded into the document file structure of the documents, thereby digitally securing them as tamper sealed documents. The tamper sealed documents can then be sent to document storage 250 to be stored.

The web server 230 can query the PDF signing function 260 and can receive a response that the tamper sealed documents have been completed. The web server 230 can store the location of the tamper sealed documents in the document storage 250.

The web server 230 can trigger a PDF portfolio call to the PDF signing function 260.

In response to receiving the PDF portfolio call, the PDF signing function 260 can retrieve the initial signed tamper sealed document, the subsequently signed tamper sealed acknowledgment document, and corresponding audit trail documents from the document storage 250.

The PDF signing function 260 can create a new PDF document from a template and can embed the initial signed tamper sealed document, the subsequently signed tamper sealed acknowledgment document, and the corresponding audit trail documents into a PDF portfolio document. In some embodiments, the system described herein can be configured to process additional document file formats and to generate portfolio documents corresponding to the additional document file formats. For example, the additional file formats can include formats associated with extensible markup language (XML) documents, hypertext markup language (HTML) documents, ZIP files, .DOC or .DOCX documents, as well as documents including structured or unstructured file formats.

A new hash or cryptographic key can be generated from the PDF portfolio document and can be sent to the HSM function 270 to be signed.

The cryptographic signature can be embedded in the PDF portfolio document to form a tamper sealed PDF portfolio document. The tamper sealed PDF portfolio document can be transmitted to the document storage 250.

The web server 230 can query the PDF signing function 260 for status of the PDF portfolio document and can receive a location of the tamper sealed PDF portfolio document in the document storage 250. The web server 230 can then transmit the location of the tamper sealed PDF portfolio document in the document storage 250 to the database 240.

The web server 230 can be queried by a notary or system administrator at the client computing device 220 and the web server 230 can receive the links to retrieve the tamper sealed PDF portfolio document from the document storage 250.

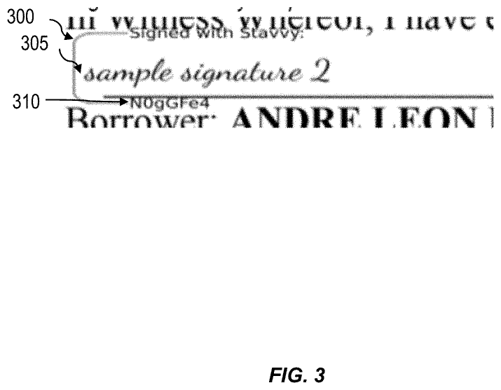

FIG. 3 illustrates an example signature including a unique signature identifier generated by the system of FIG. 2 according some embodiments of the subject matter described herein. As shown in FIG. 3, a signature block 300 can include a signature 305 and a unique signature identifier 310.

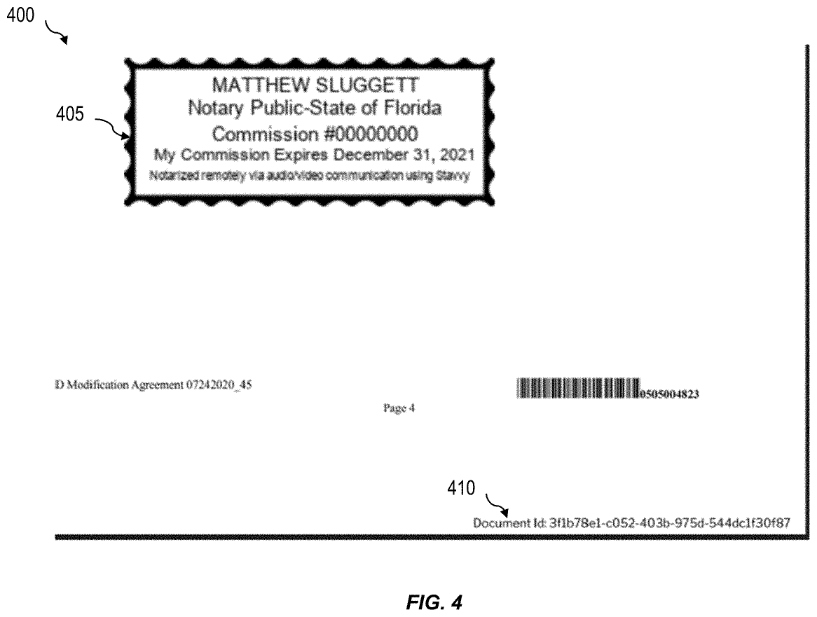

FIG. 4 illustrates an example document including a unique document identifier generated by the system of FIG. 2 according some embodiments of the subject matter described herein. As shown in FIG. 4, a document 400 can include a notary seal 405 and a unique document identifier 410.

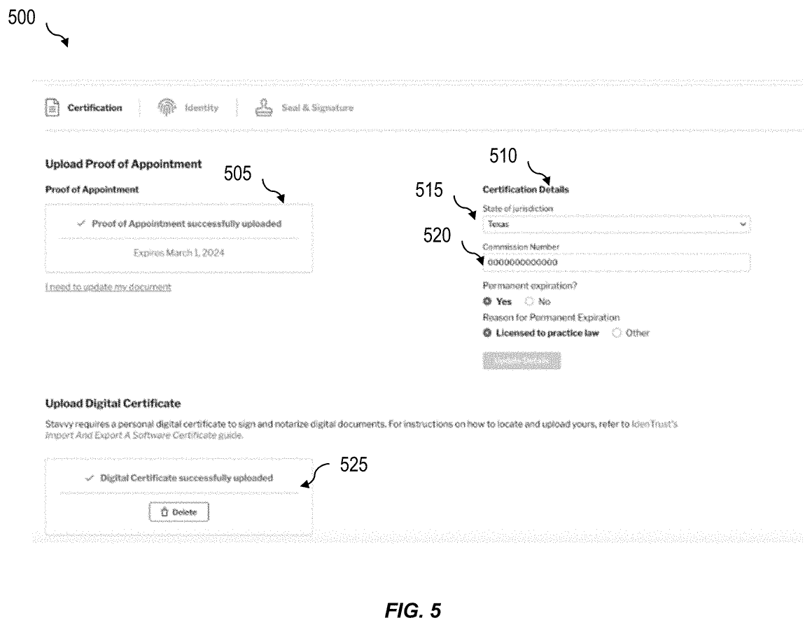

FIG. 5 illustrates an example notary profile interface provided by the system of FIG. 2 according some embodiments of the subject matter described herein. The notary profile interface 500 can include functionality for a notary or system administrator to upload proof of appointment 505, certificate details 510 including a state of jurisdiction 515, a commission number 520, and commission expiration data. The interface 500 can also include functionality for a notary to upload a personal digital certificate 525.

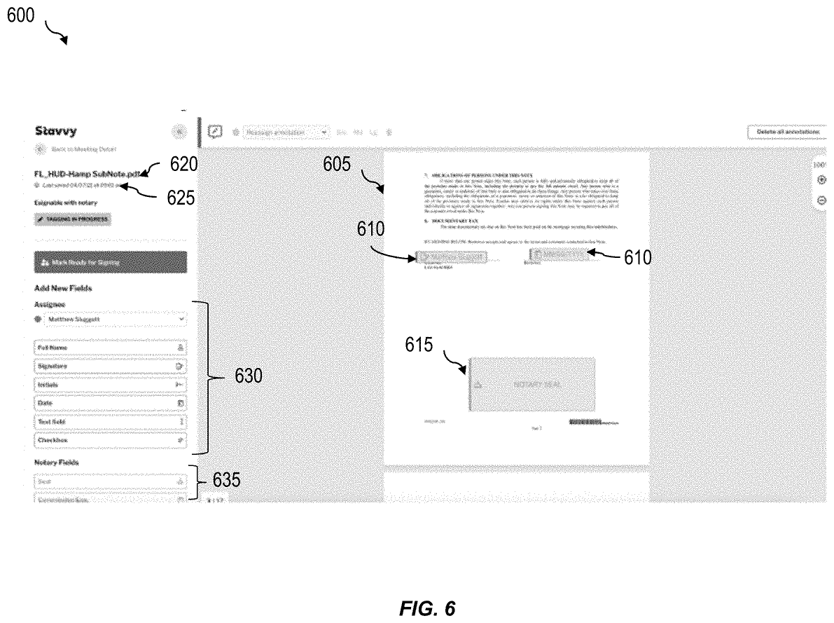

FIG. 6 illustrates an example document annotation interface provided by the system of FIG. 2 according some embodiments of the subject matter described herein. As shown in FIG. 6, the document annotation interface 600 can include a document 605 displayed with annotated signature fields 610 and an annotated notary seal field 615. The document annotation interface 600 can also include document name 620 and document status 625. The document annotation interface 600 can also include a selection of new assignee fields 630 and a selection of notary fields 635. The document annotation 600 can be configured to add selections applied to the assignee fields 630 and/or the notary fields 635 as annotated fields within the document 600.

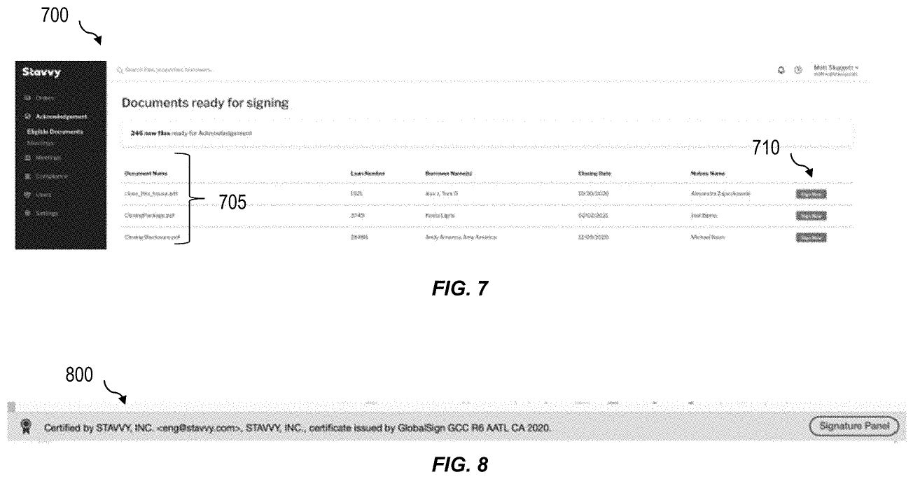

FIG. 7 illustrates an example document acknowledgement interface provided by the system of FIG. 2 according some embodiments of the subject matter described herein. The document acknowledgement interface 700 can include a list 705 of documents that are ready for signature and a link 710 to each document.

FIG. 8 illustrates an example cryptographic seal 800 provided in a document generated by the system of FIG. 2 according some embodiments of the subject matter described herein. In some embodiments, the format or representation of the cryptographic seal 800 can vary in relation to the file format of the document of which the cryptographic seal 800 is applied.

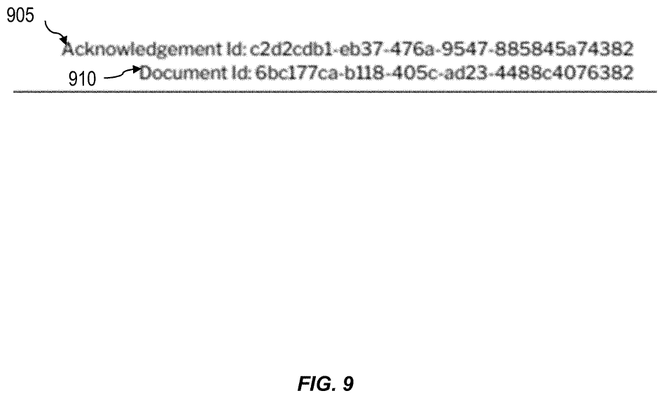

FIG. 9 illustrates an example acknowledgement identifier 905 and a document identifier 910 associated with an acknowledgment document upon which the acknowledgment identifier 905 was applied according to some example implementations of the current subject matter.

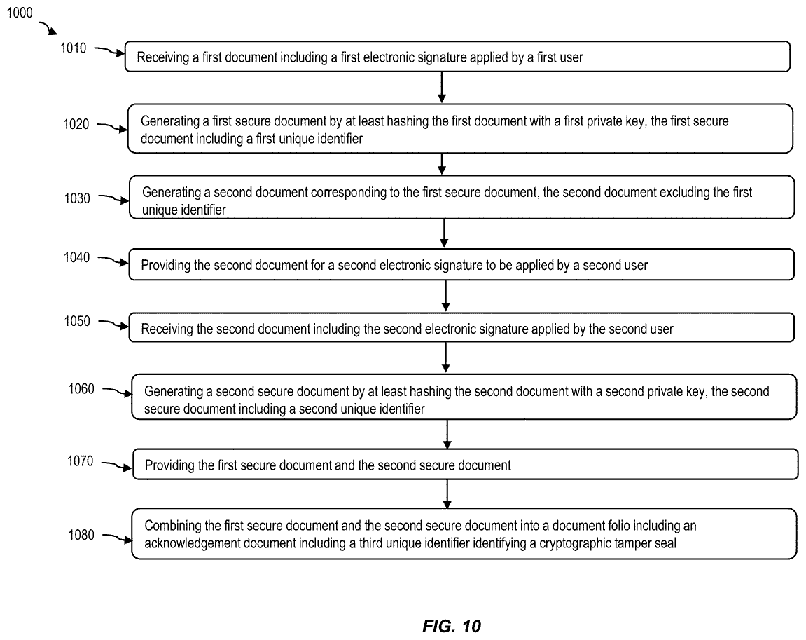

FIG. 10 is a process flow diagram illustrating an exemplary embodiment of a method 1000 performed by the system of FIG. 2. As shown in FIG. 2, at operation 1010, a first document can be received by a server, such as server 230 shown in FIG. 2. The first document can be provided to a first user and the first user can apply a first electronic signature to the first document. The received first document can include the first electronic signature applied by the first user. In some embodiments, the first document can include a hashed first document. The first document can be associated with execution of a loan document, an affidavit, a power of attorney, a deed, a property title, a deed of trust, an escrow, a will, an insurance policy, a contract, trust formation documents, deposition transcripts, health care proxies, or the like. A variety of non-limiting document types can be envisioned as the first document described herein.

At operation 1020, the server 230 can generate a first secure document by hashing the first document with a first private key. In some embodiments, the first secure document can be generated by hashing the first document using one or more secure hash algorithms (SHAs), including but not limited to SHA-256, SHA-384, or SHA-512. Signing the first hashed document with the first private key can generate and apply a first unique identifier to the first secure document. During the generation of the first secure document, the first unique identifier can be embedded within a file structure of the first secure document. In some embodiments, prior to generating the first secure document, a first annotation indicating an additional signature required to be applied to the first document by the first user can be added to the first document.

At operation 1030, the server 230 can generate a second document corresponding to the first secure document. In some embodiments, an image of the first secure document can be captured. The first unique identifier can be removed or otherwise excluded from the image and/or the second document.

At operation 1040, the server 240 can provide the second document for a second electronic signature to be applied by a second user.

At operation 1050, the server 230 can receive the second document including the second electronic signature applied by the second user.

At operation 1060, the server 230 can generate a second secure document by at least hashing the second document, including the second electronic signature, with a second private key. In some embodiments, the second secure document can be generated by hashing the second document using one or more secure hash algorithms (SHAs), such as those described in relation to operation 1020. Signing the hashed second document with the second private key can generate and apply a second unique identifier to the second secure document. During the generation of the second secure document, the second unique identifier can be embedded within a file structure of the second secure document. In some embodiments, prior to generating the second secure document, a second annotation indicating an additional signature required to be applied to the second document by the second user can be added to the second document. Advantageously the second secure document can preserve and include the first electronic signature and any annotations applied to the first document.

In some embodiments, the second secure document can include a visual representation of the first electronic signature and a visual representation of the second electronic signature. In some embodiments, the second secure document can include annotations that have been added to the first document or the second document.

In some embodiments, generating the first secure document or the second secure document can include generating a first audit list or a second audit list that can be respectively based on the first secure document or the second secure document. The first or second audit lists can include at least one of a date of an electronic signature, a name associated with an electronic signature, a license number associated with an electronic signature, or a notary seal associated with an electronic signature. It can be understood that electronic signatures can be associated with and correspond to a user or a signatory of a document.

At operation 1070, the server 230 can provide the first secure document and the second secure document. In some embodiments, the server 230 can be located remotely from client computing devices, such as the clients 220 shown in FIG. 2. The server 230 and the clients 220 can be coupled via a network, such that the server 230 and the clients 220 are physically separated by distance and are not co-located. Thus, the first user and the second user may be remote from one another and may be applying respective signatures at different times from one another. In some embodiments, the first document or the second document can be provided by the server 230 to a first user associated with a first client computing device 220 or a second user associated with a second client computing device 220, respectively. In some embodiments, the first secure document or the second secure document can be provided by the server 230 to the first client computing device 220 or the second client computing device 220.

At operation 1080, the server 230 can combine the first secure document and the second secure document into a document folio. The document folio can include a third or additional unique identifier identifying a cryptographic tamper seal associated with and applied to the document folio. The cryptographic tamper seal can include a cryptographic signature indicating that the contents of the document folio are original and have not been changed since the cryptographic tamper seal was applied to the document folio. The cryptographic signature can be embedded into the file structure of the document folio and may not be visible upon inspection of the document folio file. In some embodiments, the document folio can also include computer-readable and executable content, which when executed provides at least one of a first chronological list identifying historical data associated with application of the first electronic signature to the first document or a second chronological list identifying historical data associated with application of the second electronic signature to the second document. In some embodiments, the server 230 can provide the document folio to the first client computing device 220 (or to the first user thereof), the second client computing device 220 (or to the second user thereof), or to a third party or third party computing device.

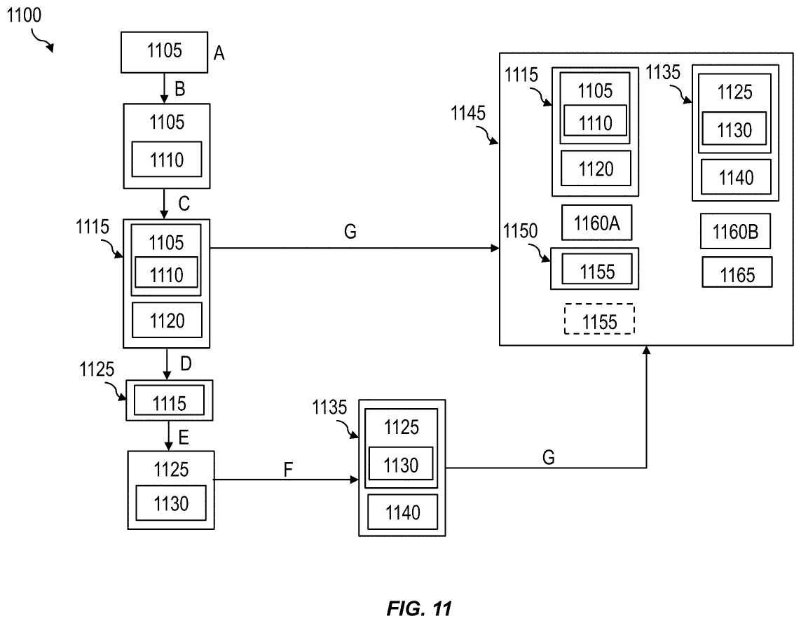

FIG. 11 is a data flow diagram illustrating an exemplary embodiment of data 1100 generated and provided by the system 210 of FIG. 2 performing exemplary embodiments of the method 1000 of FIG. 10. At A, a first document 1105 can be provided to a first user via the first client computing device 220. In some embodiments, the first document 1105 can be received by the first client computing device 220 from the server 230. The first document can be provided to the first user for signature.

At B, the first user can apply a first electronic signature 1110 to the first document 1105 via the first client computing device 220. The first document 1105 can include at least one annotation informing the first user of a location or requirement to apply their electronic signature 1110.

At C, the first client computing device 220 can provide the first document 1105 including the first electronic signature 1110 generated at B to the server 230. A first secure document 1115 can be generated by at least hashing the first document 1105 with a private key and generating a first unique identifier 1120 that can be embedded in the file structure of the first secure document 1115.

At D, the server 230 can generate a second document 1125 by capturing an image of the first secure document 1115.

At E, the server 230 can provide the second document 1125 to a second client computing device 220 for a second user to apply a second electronic signature 1130.

At F, client computing device 220 can provide the second document 1125 including the second electronic signature 1130 generated at E to the server 230. A second secure document 1135 can be generated by at least hashing the second document 1125 with a private key and generating a second unique identifier 1140 that can be embedded in the file structure of the second secure document 1135.

At G, the server 230 can combine the first secure document 1115 and the second secure document 1135 into a document folio 1145. The document folio 1145 can be provided to at least one of the first client computing device 220 or the second client computing device 220. The document folio 1145 can include an acknowledgement document 1150, which can include a third unique identifier 1155. In some embodiments, the third unique identifier 1155 can be included in the document folio 1145 and may not be included in the acknowledgement document 1150. Thus, the document folio 1145 can include a unique identifier 1155 as shown by the dashed-line unique identifier 1155. The document folio 1145 can also include audit lists 1160, that can be respectively associated with the first secure document 1115, such as audit list 1160A or the second secure document 1135, such as audit list 1160B. The document folio 1145 can also include computer-readable executable content 1165. The content 1165, when executed at the first client computing device 220 and/or the second client computing device 220 can provide at least one of a first chronological list identifying historical data associated with application of the first electronic signature to the first document or a second chronological list identifying historical data associated with application of the second electronic signature to the second document.

Although a few variations have been described in detail above, other modifications or additions are possible. For example, some implementations of the current subject matter can include execution of any other document that requires more than one signatory at different times. For example, where spouses are buying (or selling) a property together. One spouse signs today 10 AM, then the other signs at 2 PM on the same document. The visual representation is that they both signed it, but because it is signed at different times, the framework of: (a) sign, notarize, tamper seal; (b) sign, notarize, tamper seal; and (c) tamper seal portfolio as a whole allows for an audit trail for each version of the document.

In addition, some implementations of the current subject matter can include signatures without notarization. For example, the current subject matter can apply when two signers need to sign a document, the process can include be performed as described above but without notarization (e.g., (a) signer A signs a document; (b) the document is tamper sealed; (c) signer B signs; (d) document 2 is tamper sealed; and (e) the portfolio is tamper sealed). In some implementations, a unique document ID is assigned to each sealed document including prior to all signers having signed the document. In some implementations, the current subject matter can include instances in which some signer(s) sign only and others sign and notarize (e.g., combinations of sign only with sign and notarize).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a first document including a first electronic signature applied by a first user;
generating a first secure document by at least hashing the first document with a first private key, wherein the first secure document includes a first unique identifier;
generating a second document corresponding to the first secure document, the second document excluding the first unique identifier; and
providing the second document for a second electronic signature to be applied by a second user.

2. The method of claim 1, wherein prior to generating the first secure document, a first annotation indicating a third electronic signature required to be applied by the first user is added to the first document.

3. The method of claim 1, further comprising:
receiving the second document including the second electronic signature applied by the second user;
generating a second secure document by at least hashing the second document with a second private key, wherein the second secure document includes a second unique identifier; and
providing the first secure document and the second secure document.

4. The method of claim 3, wherein the second secure document includes a first visual representation of the first electronic signature and a second visual representation of the second electronic signature.

5. The method of claim 3, wherein prior to generating the second secure document, a second annotation indicating a fourth electronic signature required to be applied by the second user is added to the second document.

6. The method of claim 1, wherein the first electronic signature is applied by the first user using a first client computing device; the second electronic signature is applied by the second user using a second client computing device; and wherein generating of the second document is performed by a server remote from the first computing device and the second computing device.

7. The method of claim 1, wherein the second user is remote from the first user.

8. The method of claim 1, further comprising: providing the first document for electronic signature by the first user.

9. The method of claim 1, wherein generating the first secure document further includes embedding the first unique identifier within a file structure of the first secure document.

10. The method of claim 1, further comprising
generating a first audit list based on the first secure document; and/or
generating a second audit list based on the second secure document.

11. The method of claim 10, wherein the first audit list includes at least one of a date of the first electronic signature, a name associated with the first electronic signature, a license number associated with the first electronic signature, or a notary seal associated with the first electronic signature, and further wherein the second audit list includes at least one of a date of the second electronic signature, a name associated with the second electronic signature, a license number associated with the second electronic signature, or a notary seal associated with the second electronic signature.

12. The method of claim 1, further comprising
combining the first secure document and the second secure document into a document folio including a third unique identifier identifying a cryptographic tamper seal associated with the document folio.

13. The method of claim 12 wherein the document folio includes computer-readable and executable content, which when executed provides at least one of a first chronological list identifying historical data associated with application of the first electronic signature to the first document or a second chronological list identifying historical data associated with application of the second electronic signature to the second document.

14. The method of claim 1, wherein the first document is associated with execution of a loan document, an affidavit, a power of attorney, a deed, a property title, a deed of trust, an escrow, a will, an insurance policy, or a contract.

15. A system comprising:
at least one data processor and a memory storing machine readable instructions, which when executed by the at least one data processor perform operations comprising
receiving data characterizing a first document including a first electronic signature applied by a first user;
generating a first secure document by at least hashing the first document with a first private key, wherein the first secure document includes a first unique identifier;
generating a second document corresponding to the first secure document, the second document excluding the first unique identifier; and
providing the second document for a second electronic signature to be applied by a second user.

16. The system of claim 15, wherein prior to generating the first secure document, the instructions cause a first annotation indicating a third electronic signature to be applied by the first user to be added to the first document.

17. The system of claim 15, wherein the instructions cause the data processor to perform operations further comprising:
receiving the second document including the second electronic signature applied by the second user;
generating a second secure document by at least hashing the second document with a second private key, wherein the second secure document includes a second unique identifier; and
providing the first secure document and the second secure document.

18. The system of claim 17, wherein the second secure document includes a first visual representation of the first electronic signature and a second visual representation of the second electronic signature.

19. The system of claim 17, wherein prior to generating the second secure document, the instructions cause a second annotation indicating a fourth electronic signature to be applied by the second user to be added to the second document.

20. The system of claim 15, wherein the first electronic signature is applied by the first user using a first client computing device; the second electronic signature is applied by the second user using a second client computing device; and wherein generating of the second document is performed by a server remote from the first computing device and the second computing device.

21. The system of claim 15, wherein the second user is remote from the first user.

22. The system of claim 15, wherein the instructions cause the data processor to perform operations further comprising:
providing the first document via a display of the first computing device for electronic signature by the first user.

23. The system of claim 15, wherein generating the first secure document further includes embedding the first unique identifier within a file structure of the first secure document.

24. The system of claim 1, wherein the instructions cause the data processor to perform operations further comprising
generating a first audit list based on the first secure document; and/or
generating a second audit list based on the second secure document.

25. The system of claim 24, wherein the first audit list includes at least one of a date of the first electronic signature, a name associated with the first electronic signature, a license number associated with the first electronic signature, or a notary seal associated with the first electronic signature, and further wherein the second audit list includes at least one of a date of the second electronic signature, a name associated with the second electronic signature, a license number associated with the second electronic signature, or a notary seal associated with the second electronic signature.

26. The system of claim 15, wherein the instructions cause the data processor to perform operations further comprising:
combining the first secure document and the second secure document into a document folio including a third unique identifier identifying a cryptographic tamper seal associated with the document folio.

27. The system of claim 26, wherein the document folio includes computer-readable and executable content, which when executed provides at least one of a first chronological list identifying historical data associated with application of the first electronic signature to the first document or a second chronological list identifying historical data associated with application of the second electronic signature to the second document.

28. The system of claim 15, wherein the first document is associated with execution of a loan document, an affidavit, a power of attorney, a deed, a property title, a deed of trust, an escrow, a will, an insurance policy, or a contract.
